(19) United States
(12) Patent Application Publication
(10) Pub. No.: US 2013/0008887 A1
(43) Pub. Date: Jan. 10, 2013

(54) Water Heating System

(76) Inventor: Wan Chun Hsu, Hsinchu County (TW)

(21) Appl. No.: 13/541,981

(22) Filed: Jul. 5, 2012

(30) Foreign Application Priority Data
Jul. 7, 2011 (TW) 100123979

(51) Int. Cl. H05B 6/10; H05B 6/02

(52) U.S. Cl. 219/601; 219/618

(57) ABSTRACT

A water heating system includes a power receiving module for receiving wind power and a heat generating module. The power receiving module further includes a fan unit and a transmission unit. The heat generating module connected with the transmission unit further includes at least one flywheel, a plurality of permanent magnets, at least one electric conductive member and at least one water jacket member. The fan unit driven by winds rotates the flywheel as well as the permanent magnets through the transmission unit, such that the permanent magnets can rotate about the electric conductive member so as to cause the electric conductive member to generate heat. The heat is then introduced by conduction to heat up the medium contained in the water jacket member, and thus the thermal energy can be stored into a heat-storing tank.

This application claims the benefit of Taiwan Patent Application Serial No. 100123979, filed Jul. 7, 2011, the subject matter of which is incorporated herein by reference.

### BACKGROUND OF INVENTION

1. Field of the Invention

The invention relates to a water heating system, and more particularly to the system that utilizes a fan unit to drive plural permanent magnets inside a heat generating module to rotate about an electric conductive member so as to generate and further forward heat to a water jacket member, and thereby the heat can be stored into water or the like thermal conductive medium in the water jacket member.

2. Description of the Prior Art

In the art, the wind turbine power generation system is known to be one of modern environment-friendly power generation systems, which utilizes wind turbines to collect wind power by activating a generator to generate electric energy. Currently, the wind turbine power generation system needs a large number of expensive electronic devices and also has an inacceptable limit in output power. Thus, the wind turbine power generation system can only be seen in a large-scale power supply facilities, and is definitely not popular to ordinary consumers.

Another well-known power generation system is the solar energy system, in which electric energy is obtained from transforming the heat energy. One of the shortcomings in the solar energy system, either a parallel power regeneration system or a direct heating system, is the cost for the energy.

Further, in a conventional solar heat energy system, the solar energy is collected to produce the heat energy. Yet, such a system is highly climate-independent. In the cold winter, poor sunshine usually reduces the collection in solar energy, and as a consequence an auxiliary heating system is required for the dark night usage. Also, obvious disadvantages of the solar system are its space occupation and again the cost.

Accordingly, the present invention is devoted to introducing the wind power to directly produce the thermal energy without any intern transformation step. Thereupon, the complexity in structuring and the cost can be substantially reduced. In the present invention, an obvious advantage can be obtained by waiving the wind power generator, so that cost in coiling and power loss for transformation and internal friction in the generator can thus be avoided. Also, in the present invention, the achievement in simple-structuring, energy saving and environment protection is superior to most of the conventional water heating system in the marketplace. By providing the present invention, no matter what the time is in day or night, as long as there is a wind, there is heated water available. In particular, in the chilly winter or in a polar climate, the water heating system of the present invention can be still prevailed.

### SUMMARY OF THE INVENTION

It is the primary object of the present invention to provide a water heating system, which introduces the wind to drive a power receiving module and activates a heat generating module to produce the thermal energy by magnet-induced eddy currents. In the present invention, no more the conventional indirect method of obtaining the thermal energy from transforming the electric energy is required; so that the energy-production cost can be reduced by avoiding complicate coiling and circuiting structure in electric generators.

In the present invention, the water heating system includes a power receiving module and a heat generating module. The power receiving module further includes a fan unit and a transmission unit. The heat generating module connected with the transmission unit further includes at least a flywheel, a plurality of permanent magnets, at least an electric conductive member and at least a water jacket member. Upon the wind power to rotate the fan unit so as to further rotate the permanent magnets on the flywheel via the transmission unit, changes in magnetic field occur at the predetermined spacing between the permanent magnets and the electric conductive members fixed to the water jacket member. While the electric conductive members meet the changes in the magnetic field, eddy currents would be induced to further generate heat. The heat is conducted into the water jacket member so as to heat up the heat conduction medium inside the water jacket member, in which the heat conduction medium can be a fluid or a gas. Upon such an arrangement, the wind power can be transformed into the thermal energy in a more direct way without intern interchanging of the electric energy.

All these objects are achieved by the water heating system described below.

### BRIEF DESCRIPTION OF THE DRAWINGS

The present invention will now be specified with reference to its preferred embodiment illustrated in the drawings, in which:

FIG. 1 is a schematic view of a first embodiment of the water heating system in accordance with the present invention;

FIG. 2 is a schematic view of a preferred power receiving module and a preferred heat generating module of the water heating system in accordance with the present invention;

FIG. 3 shows schematically the magnetic lines between the electric conductive member and the permanent magnets of the water heating system in accordance with the present invention;

FIG. 4 shows schematically the induced eddy currents at the water heating system in accordance with the present invention;

FIG. 5 illustrates an arrangement of the round permanent magnets of the water heating system in accordance with the present invention;

FIG. 6 illustrates an arrangement of the trapezoidal permanent magnets of the water heating system in accordance with the present invention;

FIG. 7 shows schematically the internal flow of a first embodiment of the water jacket member for the water heating system in accordance with the present invention;

FIG. 8 shows schematically the internal flow of a second embodiment of the water jacket member for the water heating system in accordance with the present invention;

FIG. 9 shows schematically a first embodiment of the heat generating module for the water heating system in accordance with the present invention;

FIG. 10 shows schematically a second embodiment of the heat generating module for the water heating system in accordance with the present invention;

FIG. 11 shows schematically a third embodiment of the heat generating module for the water heating system in accordance with the present invention;

FIG. 12 shows schematically a fourth embodiment of the heat generating module for the water heating system in accordance with the present invention;

FIG. 13 is a side view of FIG. 12;

FIG. 14 is a perspective view of FIG. 12;

FIG. 15 is a schematic view of a first embodiment of the position adjusting mechanism for the water heating system in accordance with the present invention;

FIG. 16 is a schematic view of a second embodiment of the position adjusting mechanism for the water heating system in accordance with the present invention;

FIG. 17 is a schematic view of a third embodiment of the position adjusting mechanism for the water heating system in accordance with the present invention;

FIG. 18 is a schematic view of a second embodiment of the water heating system in accordance with the present invention; and

FIG. 19 is a schematic view of a third embodiment of the water heating system in accordance with the present invention.

### DESCRIPTION OF THE PREFERRED EMBODIMENT

The invention disclosed herein is directed to a water heating system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

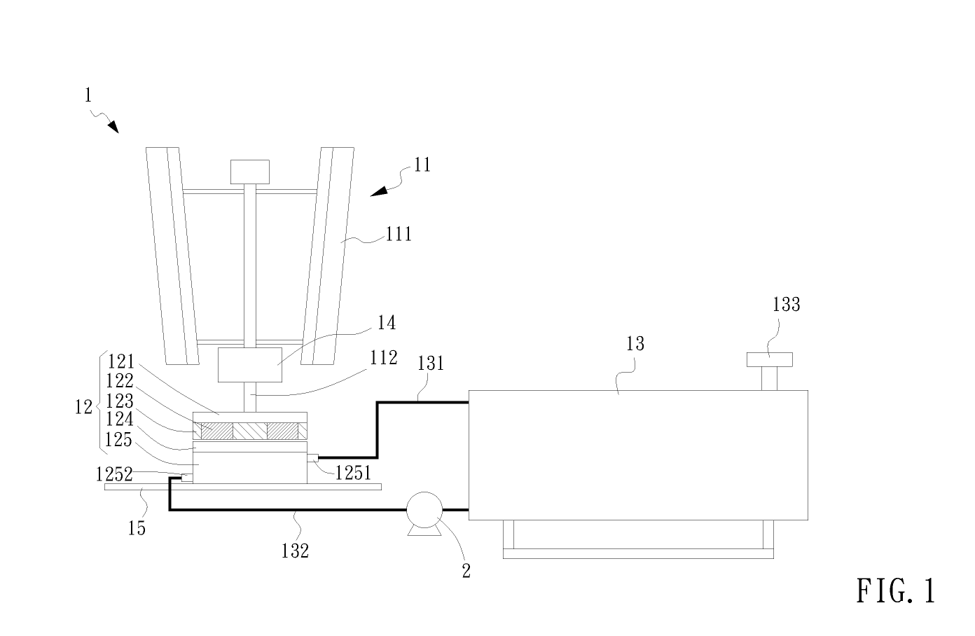

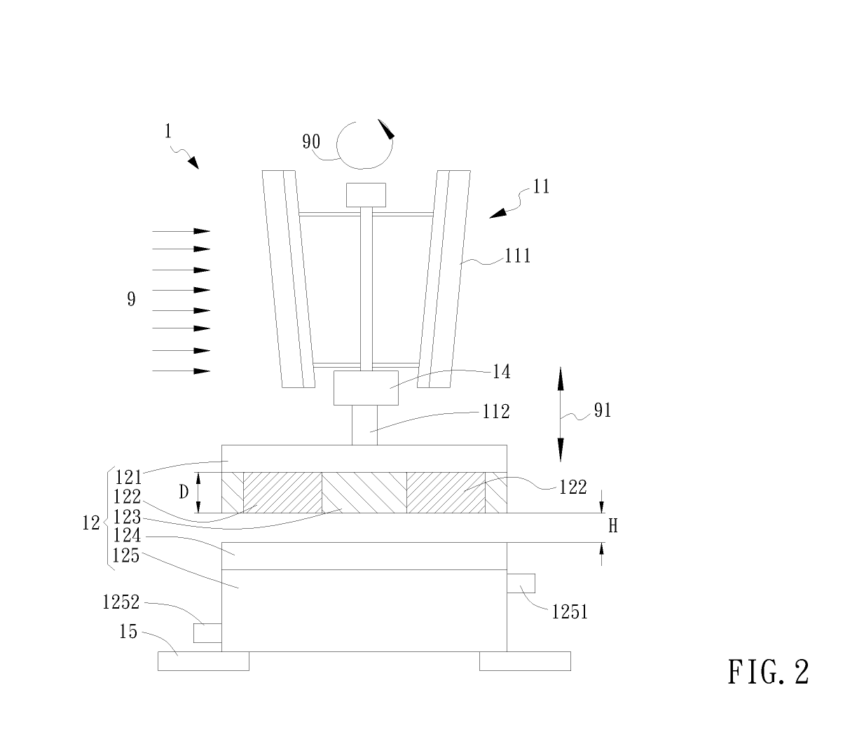

Referring now to FIG. 1 and FIG. 2, a schematic view of a first embodiment of the water heating system and a schematic view of the power receiving module and the heat generating module for the water heating system in accordance with the present invention are shown, respectively. The water heating system 1 is mainly driven by wind power 9; or, in some other embodiments not shown here, by water power, tidal power, or any nature flow the like. The water heating system 1 includes a power receiving module 11, a heat generating module 12, a heat storing module 13, a position adjusting mechanism 14 and a chassis 15. The power receiving module 11 mounted at a predetermined height from the ground by a casing or a frame (not shown in the figure) includes a fan unit 111 and a transmission unit 112. The heat generating module 12 further includes at least one flywheel 121, a plurality of permanent magnets 122, a magnet frame 123, at least one electric conductive member 124 and at least one water jacket member 125.

The transmission unit 112 of the power receiving module 11 is coupled in motion with the flywheel 121 of the heat generating module 12. The permanent magnets 122 mounted on the flywheel 121 by the magnet frame 123 are spaced by a predetermined spacing H with the electric conductive members 124 fixed on the water jacket member 125. The water jacket member 125 as well as the electric conductive members 124 are mounted fixedly onto the chassis 15. Through relevant arrangements in shapes, structures and related positions on parts of the fan unit 111, the wind power 9 or the like nature flow can drive the fan unit 111 of the power receiving module 11 so as to contribute a downward force 91. With the rotation of the transmission unit 112 and self-adjustment in the position adjusting mechanism 14, the spacing H between the permanent magnets 122 and the electric conductive member 124 can be changed (narrowed for example) so as to promote the heating by the electric conductive members 124.

While the fan unit 111 of the power receiving module 11 is driven by wind power 9, a rotation 90 is generated to drive the heat generating module 12 so as to obtain thermal energy, from magnetic transformation, by the electric conductive members 124. The thermal energy, or say the heat, generated at the electric conductive members 124 is then forwarded by conduction to the heat conduction medium (a fluid or a gas, preferably a fluid like water) inside the water jacket member 125. The heated heat conduction medium is then stored by convection flow to the heat storing module 13. In the present invention, the water jacket member 125 wrapped completely by a thermal-proof material includes at least a water outlet 1251 and a water inlet 1252. The heat storing module 13 and the water jacket member 125 are formed as a close fluid loop by having an intake pipe 131 and an outgo pipe 132 of the heat storing module 13 to connect with the water outlet 1251 and the water inlet 1252 of the water jacket member 125, respectively. Upon such an arrangement, an internal thermal flow loop between the water jacket member 125 and the heat storing module 13 for the internal heat conduction medium can be thus established.

In the present invention, the water heating system 1 applies the heat convection to automatically circulate the heat conduction medium inside the water jacket member 125 and the heat storing module 13. In addition, the water heating system 1 of the present invention can further include an auxiliary circulation module 2 to help the circulation of the heat conduction medium inside the heat storing module 13 and the water jacket member 125. The auxiliary circulation module 2 can be a wind pump located at a predetermined position of the outgo pipe 132 of the heat storing module 13. The heat storing module 13 can also have an exhaust pipe 133 for expelling hot air thereof. In one embodiment of the present invention, the wind pump (the auxiliary circulation module 2) can be directly driven by the heat generating module 12. In another embodiment, the auxiliary circulation module 2 may have its own power source; for example, an external electricity, an additional wind-powered fan unit, or any the like.

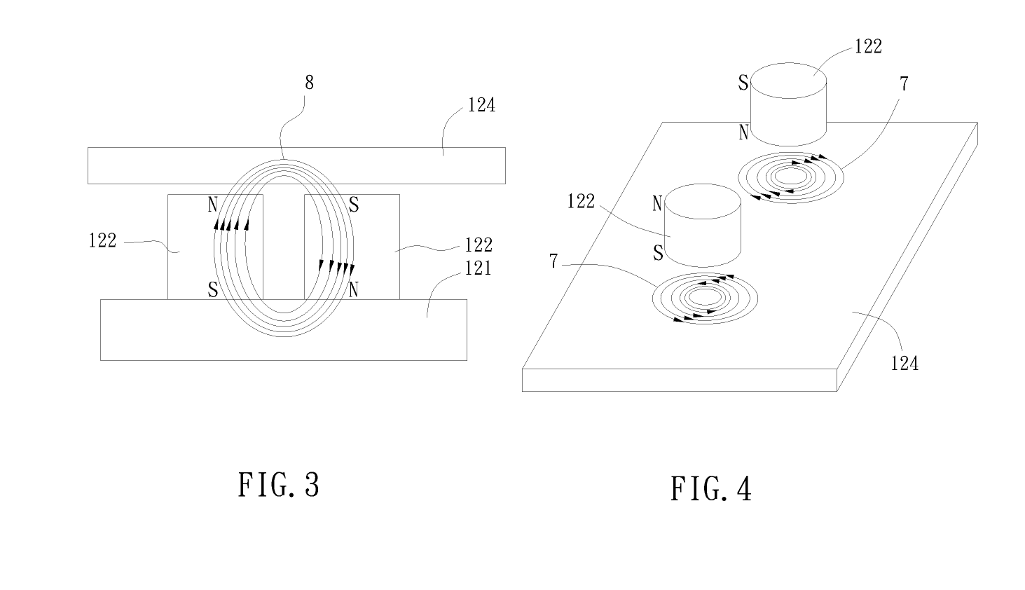

Refer further to FIG. 3 and FIG. 4 by accompanying FIG. 1 and FIG. 2, in which FIG. 3 shows schematically the magnetic lines between the electric conductive members 124 and the permanent magnets 122 of the water heating system 1, and FIG. 4 shows schematically the induced eddy currents at the water heating system 1. By providing the wind power 9 to rotate the fan unit 111 and further to rotate the flywheel 121 via the transmission unit 112, the permanent magnets 122 on the flywheel 121 is rotated with respect to the electric conductive members 124 fixed on the water jacket member 125. Thereby, a plurality of magnetic lines 8 is generated in the space between the flywheel 121 and the electric conductive members 124 so as to induce changes in magnetic field in between. An eddy current 7 can thus be formed while the magnetic field sweeps over the electric conductive members 124. The eddy currents 7 on the electric conductive members 124 can induce heat generation in the electric conductive members 124. The heat generated inside the electric conductive members 124 is then flowed by heat conduction to be absorbed by the heat conduction medium inside the water jacket member 125. Further, the heated heat conduction medium is flowed by heat convention into the heat storing module 13.

In the basic electricity theory, it is well known that the power is proportional to the square of the current. Also, the smaller the electric resistance coefficient of the electric conductive member 124 is, the easier the electric conduction can be, the more thermal energy can be produced, and the larger rotational resistance the power receiving module 11 needs to encounter. Namely, in the present invention, the material for the electric conductive member 124 of the heat generating module 12 must be an excellent electric conduction material, such as a gold, silver, copper, iron, aluminum, or alloy of any combination of the foregoing metals. In one embodiment of the present invention, the electric conductive member 124 is preferably made of a pure aluminum for its excellent properties in non-magnets, electric conduction, thermal conduction, and less costing by compared to the gold and silver. With such a material choice in the electric conductive member 124, the heat generated in the electric conductive member 124 can be rapidly conducted to the heat conduction medium inside the water jacket member 125.

In the present invention, the magnetic force of the permanent magnet 122 is also one of factors for forming the eddy current 7. Theoretically, according to the Lenz law, the larger the magnetic field is (symbolized by condenser magnetic lines 8 in FIG. 3), the more eddy currents 7 can then be produced (in FIG. 4).

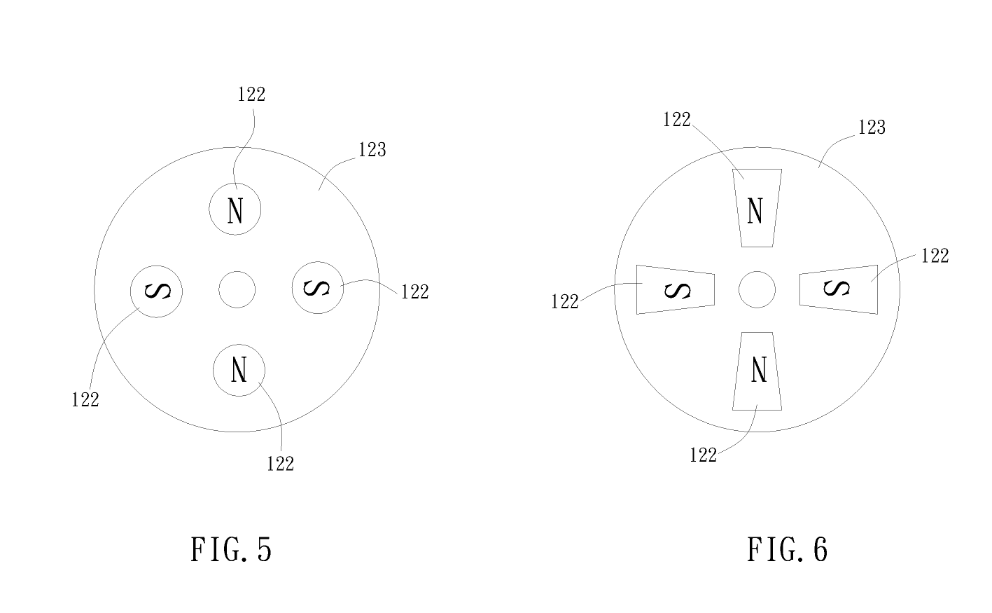

Referring now to FIG. 5 and FIG. 6, individual arrangements for round and trapezoidal permanent magnets 122 are schematically shown, respectively. In the first embodiment of the present invention, the permanent magnet 122 is made of a magnetic material with strong magnetic properties. The plurality of the permanent magnets 122 are mounted on the flywheel 121 in a circulation manner with the help of the magnet frame 123. The flywheel 121 can be made of a magnet-conductive material, such as a material containing iron or the like. With a proper determination in thickness of the flywheel 121, the magnet-conduction can be enhanced and the production cost can be reduced.

In the present invention, the number of the permanent magnets 122 shall be at least four (i.e. two pairs). As shown in either FIG. 5 or FIG. 6, two pairs of the permanent magnets 122 are shown. Each of the permanent magnets 122 is embedded fixedly in the magnet frame 123. The magnet frame 123 protects the permanent magnets 122 from being projected away by the centrifugal force produced by the rotation of the flywheel 121 driven by the transmission unit 112 of the power receiving module 12. Also, the rusting problem in the permanent magnets 122 can be thus be lessened.

In the present invention, the magnet frame 123 can be made of a non-magnetic material, such as aluminum, stainless steel, Bakelite plate, resin or any non-magnetic material the like. While inserting the permanent magnets 122 into the magnet frame 123, a high temperature resistant resin, rubber or any material the like can be filled into the spacing around the permanent magnets 122 so as to anchor fixedly the permanent magnets 122 and also able to obtain advantages in moisture proof and anti-corrosion. As the permanent magnets 122 are settled in the magnet frame 123, the heads of the permanent magnets 122 can be located under, above or flush with the exterior surface of the magnet frame 123. Preferably, the permanent magnets 122 are mounted completely inside the magnet frame 123 so as to reduce the wind resistance and the risk of interfering the rotation of the flywheel 121. In the present invention, the permanent magnet 122 can be round, trapezoidal, triangular, polygonal, or any irregular-cross sectional cylindrical shape the like.

In addition, as shown in FIG. 5 and FIG. 6, any two neighboring magnets 122 are preferred to have different polarities. Referred back to FIG. 2, it can be easier to understand that the thickness D of the permanent magnet 122 would affect the strength of the magnetic field and the distribution of the magnetic lines 8 as well. Preferably, the thickness D for the permanent magnet 122 is at least more than 5 mm. In the present invention, the polarities of the permanent magnets 122 can be arbitrarily arranged. Yet, it should be aware that the heating performance of the electric conductive member 124 would be highly related to the arrangement of the permanent magnets 122.

It shall be understood that, though the arrangements of the permanent magnets 122 may be various, yet the arrangement of switching polarity for neighboring magnets 122 as shown in either FIG. 5 or FIG. 6 is the preferred one. Further, as the neighboring magnets 122 have different polarities, the induced magnetic lines 8 would be inter-looped. By providing the attraction between neighboring magnets 122, the magnetic lines 8 can pass the neighboring magnetic field easier with less magnetic rejection. Thereby, local magnetic resistance can be reduced to a minimum. By compared to the loop of the magnetic lines of the individual permanent magnet 122, the phenomenon of cutting through the high magnetic resistant air can be avoided.

In the present invention, the formation of the magnetic lines is also affected by the shape of the permanent magnet 122, the spacing in between, and the operational parameters. In particular, it is favorite to have a larger magnetic surface of the permanent magnet 122 to face the electric conductive member 124. In such a consideration in strength of the induced magnetic field as well as the heating performance, the embodiment shown in FIG. 6 for the trapezoidal permanent magnets 122 would be more preferable than that shown in FIG. 5 for round permanent magnets 122.

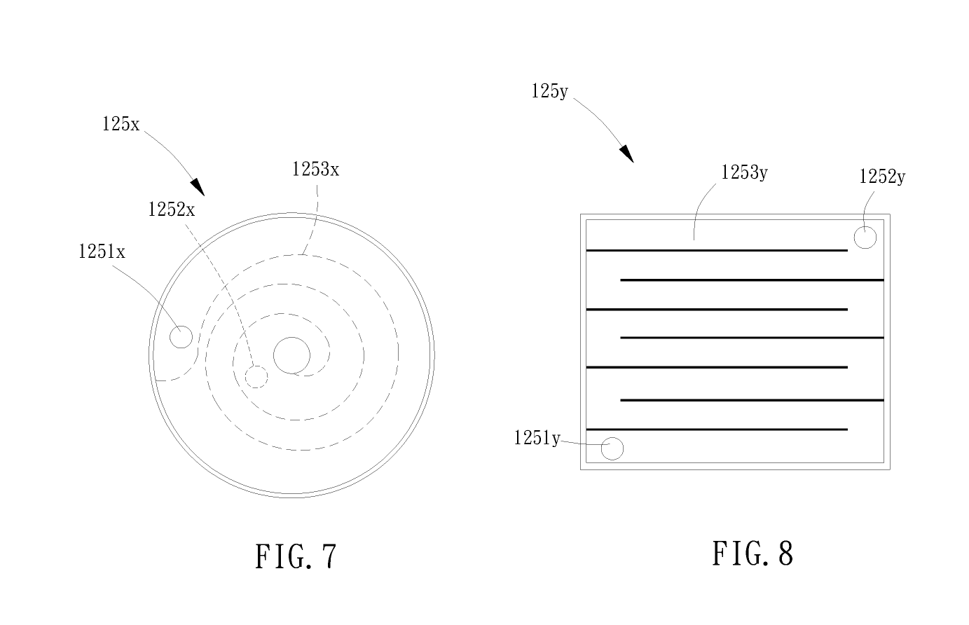

Referring now to FIG. 7 and FIG. 8, internal flows of a first embodiment and a second embodiment of the water jacket member 125 for the water heating system in accordance with the present invention are shown, respectively. The water jacket member 125 can be produced as a unique piece or be assembled by parts. Further, the water jacket member 125 can be made of a non-metallic material or some other anti-corrosive materials. Also, the water jacket member 125 for the heat generating module 12 can be a round-shape water jacket member 125x as shown in FIG. 7, or a square-shape water jacket member 125y as shown in FIG. 8.

As shown in FIG. 7, the first embodiment 125x of the water jacket member is round shaped to have an interior machined to include a sealed spiral structure 1253x. An water outlet hole 1251x and a water inlet hole 1252x are provided respectively to opposing ends of the round water jacket member 125x so as to establish flow-connection with the heat storing module 13. The spiral structure 1253x machined to the interior of the round water jacket member 125x is to regulate the heat conduction medium inside the water jacket member 125x to flow in a specific direction and so as to speed up the circulation and outflow of heat. In the present invention, the water jacket member can also be rectangular, rhombic, or any other appropriate polygonal shape.

Similarly, as shown in FIG. 8, the second embodiment 125y of the water jacket member is a square water jacket member having an interior machined into a sealed winding structure 1253y for promoting efficiently the circulation of the heat conduction medium and the heat conduction from the electric conductive member 124 to the heat conduction medium. Also, an water outlet hole 1251y and a water inlet hole 1252y are provided respectively to opposing ends of the square water jacket member 125y so as to establish flow-connection with the heat storing module 13.

In the present invention, no matter that the water jacket member 125 is round or square, in order for its interior to flow the heat conduction medium that absorbs the thermal energy from the electric conductive member 124, strips or pastes of temperature resistant silicon are needed to help the screw-fastening and sealing between the water jacket member 125 and the electric conductive member 124 while in assembling. Alternatively, a copper or aluminum washier can also be applied thereof in between for directly fastening.

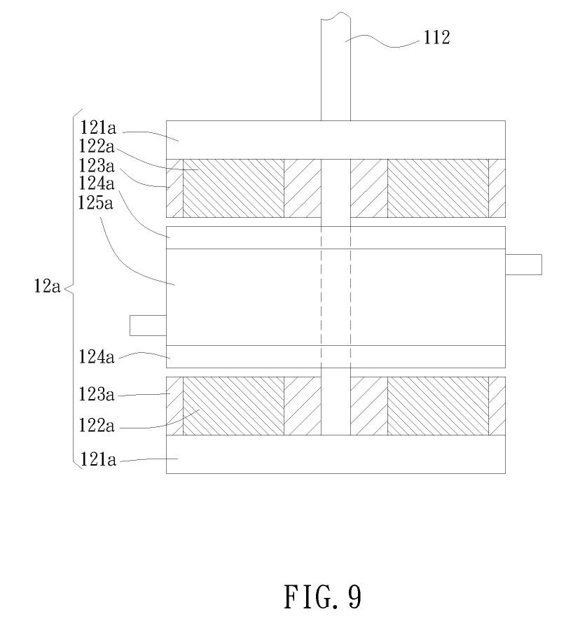

Referring now to FIG. 9, a first embodiment 12a of the heat generating module in accordance with the present invention is schematically shown. The heat generating module 12a includes two flywheels 121a, two sets of the permanent magnets 122a (each set includes a plurality of the permanent magnets 122a), two magnet frames 123a, two electric conductive members 124a and a water jacket member 125a. The two magnet frames 123a mounted to the respective flywheels 121a have individually the corresponding sets of the circular-arranged permanent magnets 122a. The two electric conductive members 124a are located to opposing sides of the water jacket member 125a. The rotational motion to the two flywheels 121a is provided from the transmission unit 112 of the power receiving module 11. As shown, the heat generating module 12a is formed as a symmetric structure between two flywheels 121a and around the transmission unit 112 by having the water jacket member 125a located at a central portion, the two electric conductive members 124a located to two opposing off-center sides of the water jacket member 125a, and the two magnet frames 123a as well as the accompanying permanent magnets 122a located inner to the corresponding flywheels 121a but closing to the corresponding electric conductive members 124a by a predetermined spacing.

It is noted that two sides of the water jacket member 125a have, by fixedly mounting, the individual electric conductive members 124a, which are further accounted respectively to the corresponding permanent magnets 122a. Upon such an arrangement, the heat generating module 12a can obtain heat simultaneously from the two electric conductive members 124a located at both sides of the water jacket member 125a. Also, for the two sets of the permanent magnets 122a are separated in both the positioning manner and the heat generation manner, thus the water jacket member 125a can be rapidly heated up and the thermal energy can be quickly transmitted to the heat conduction medium inside the water jacket member 125a.

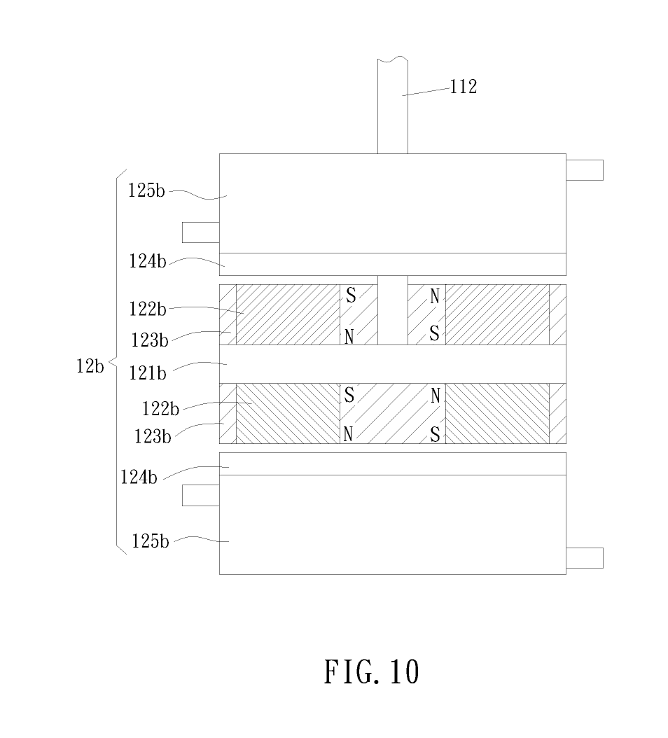

Referring now to FIG. 10, a second embodiment 12b of the heat generating module in accordance with the present invention is schematically shown. The heat generating module 12b includes a flywheel 121b, two sets of the permanent magnets 122b (each set includes a plurality of the permanent magnets 122b), two magnet frames 123b, two electric conductive members 124b and two water jacket members 125b. The two magnet frames 123b are mounted to opposing sides of the central flywheel 121b and have individually the corresponding sets of the circular-arranged permanent magnets 122b. The two electric conductive members 124b are located to corresponding inner sides (with respect to the second embodiment 12b) of the opposing water jacket members 125b and separated from the corresponding permanent magnets 122b by a predetermined spacing. The rotational motion provided to the central flywheel 121b (between the two water jacket members 125b) is introduced from the transmission unit 112 of the power receiving module 11. The rotational motion is further to drive the permanent magnets 122b located on both sides of the flywheel 121b so as to induce corresponding eddy currents 7 on the respective electric conductive members 124b. Thereby, the heat can be generated at the two electric conductive members 124b and can be further transmitted to the heat conduction media inside the corresponding water jacket members 125b.

As shown in FIG. 10, the permanent magnets 122b on the corresponding magnet frames 123b are symmetrically arranged. In the present invention, polarities of the permanent magnets 122b to the opposing surfaces of the flywheel 121b can be identical or different. Namely, two patterns of the polarity arrangement to the permanent magnets 122b of the second embodiment 12b can be one of N/S-flywheel-N/S as shown in FIG. 10 or another of N/S-flywheel-S/N (not shown I the figure). Though the aforesaid two patterns of the polarity arrangement are different and thus formulate different patterns of the magnetic lines 8, yet either of the two polar patterns can still have the two electric conductive member 124b to generate heat for heating up the corresponding heat conduction media inside the respective water jacket members 125b.

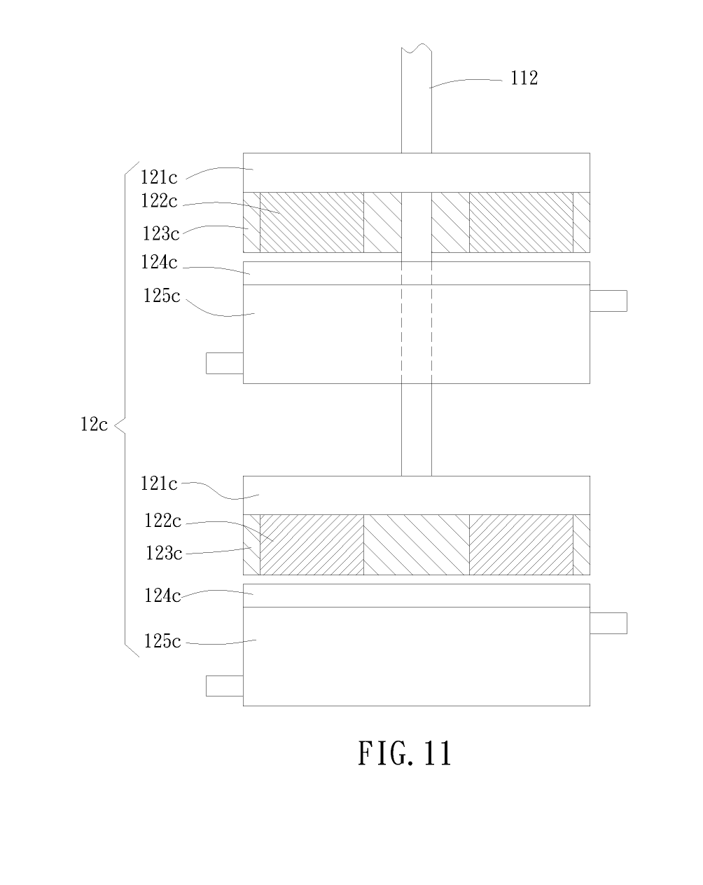

Referring now to FIG. 11, a third embodiment 12c of the heat generating module in accordance with the present invention is schematically shown. The heat generating module 12c includes two flywheels 121c, two sets of the permanent magnets 122c (each set includes a plurality of the permanent magnets 122c), two magnet frames 123c, two electric conductive members 124c and two water jacket members 125c. The two magnet frames 123c are mounted under to the corresponding flywheels 121c and have individually the corresponding sets of the permanent magnets 122c. The two electric conductive members 124b are located beneath to the corresponding magnet frames 123c as well as the permanent magnets 122c by a predetermined spacing. The two water jacket members 125c are further located fixedly under the corresponding electric conductive members 124c. As shown, it is noted that the third embodiment 12c is formed by two identical heat generating units, in which the two flywheels 121c are identically and simultaneously driven by the transmission unit 112 of the power receiving module 11. Namely, in the third embodiment 12c, the two independent heat generating units can be coaxially driven by the same transmission unit 112 of the power receiving module 11.

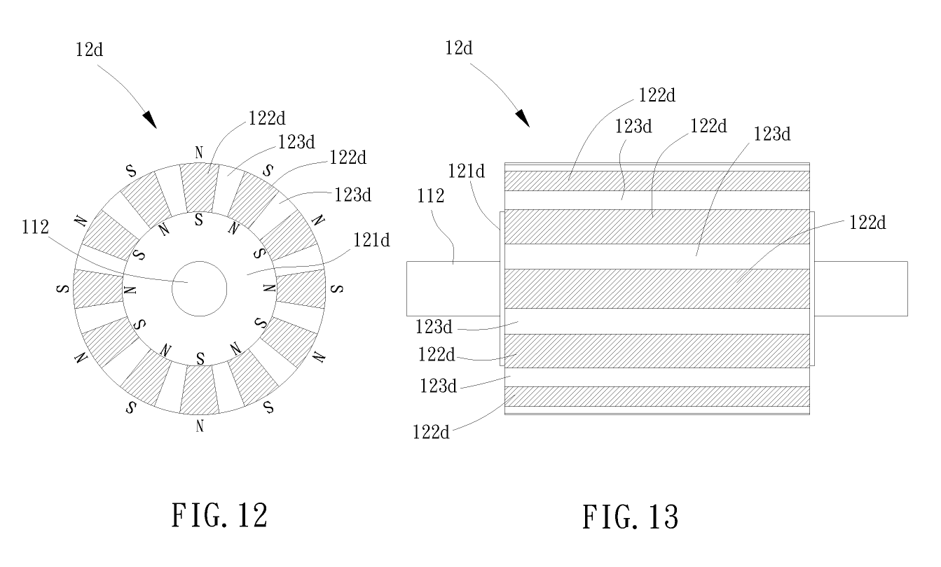

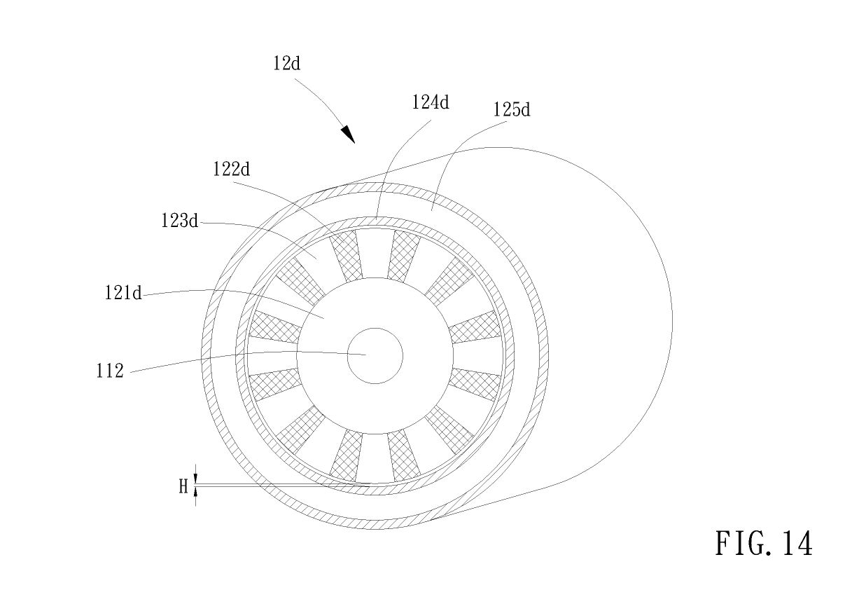

Referring now to FIG. 12, FIG. 13 and FIG. 14, a front view, a lateral side view and a perspective view of a fourth embodiment 12d of the heat generating module in accordance with the present invention are schematically shown, respectively. As shown, the fourth embodiment 12d includes a plurality of trapezoidal permanent magnets 122d arranged circularly around a cylindrical flywheel 121d. A magnet frame 123d for mounting the permanent magnets 122d is structured to have protrusions to separate every two adjacent magnets 122d and to integrate the permanent magnets 122d so as to form a rotor with the cylindrical flywheel 121d. The rotor can be formed as a squirrel-cage motor driven by the transmission unit 112 of the power receiving module 11 who couples the central cylindrical flywheel 121d. The water jacket member 125d is a hollow cylindrical structure, and the electric conductive member 124d is formed as an inner shell fixed to the hollow cylindrical water jacket member 125d, but outer to the permanent magnets 122d by a predetermined annular spacing H. The rotor combo (i.e. the flywheel 121d, the magnet frame 123d and the permanent magnets 122d) is rotationally driven by the transmission unit 112 of the power receiving module 11 so as to perform magnetic thermal transformation between the permanent magnets 122d and the electric conductive member 124d.

In the present invention, factors for affecting the heat generation of the heat generating module 12d having the squirrel-cage motor type rotor include the speed of the power receiving module 11 and the effective magnetic surfaces of the permanent magnets 122d and the electric conductive member 124d, and the annular spacing H between the permanent magnets 122d and the electric conductive member 124d. It is noted that a smaller H would be preferable in an efficiency consideration.

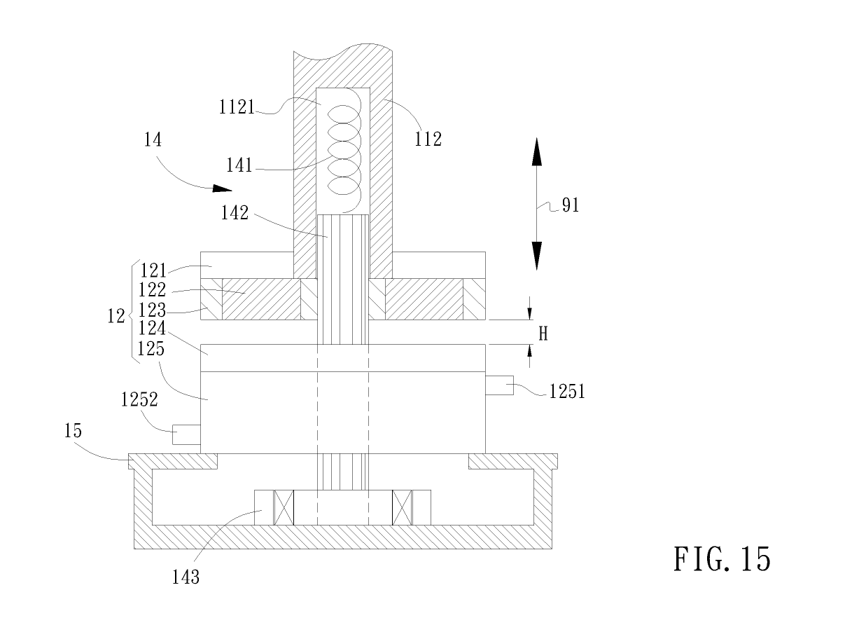

Referring now to FIG. 15 by further referring to FIG. 2, a first embodiment of the position adjusting mechanism for the water heating system in accordance with the present invention is schematically shown. The position adjusting mechanism 14 for adjusting the spacing H between the permanent magnets 122 and the electric conductive member 124 is located between the power receiving module 11 and the heat generating module 12, in which the spacing H is a major factor to affect the heating performance of the water heating system according to the present invention. The spacing H can be varied by an electric manner or a mechanical mechanism. In the case of the mechanical mechanism, a downward forcing will be generated while the rotational kinetic energy 90 is applied to the fan unit 111 driven by the wind power 9. Such a downward forcing is then introduced to shift down the power receiving module 11 and to narrow the spacing H.

As shown in FIG. 15, the position adjusting mechanism 14 is purely mechanical. The electric conductive member 124 and the water jacket member 125 of the heat generating module 12 are fixed to the chassis 15. As shown, an elastic element 141 is accommodated inside a central hollow slot 1121 of the transmission unit 112. A spline shaft 142 of the position adjusting mechanism 14 protrudes upward to depress upon the elastic element 141 inside the hollow slot 1121. Noted that an end portion of the spline shaft 142 is sleeved thereinside in the hollow slot 1121 of the transmission unit 112, while another end portion thereof is hold by a bearing 143 located at the chassis 15. Also, the spline shaft 142 is allowed to slide longitudinally inside and along the transmission unit 112, but rotation in between is prohibited. Upon such an arrangement, as the transmission unit 112 is driven to rotate by the fan unit 111, the spline shaft 142, the flywheel 121 and the permanent magnets 122 are synchronically moved with the transmission unit 112. At this time, for a downward forcing 91 upon the transmission unit 112 is contributed from the forcing on the power receiving module 11 by the wind power 9, the spacing H between the permanent magnets 122 movable with the flywheel 121 as well as the transmission unit 112 and the stationary electric conductive member 124 fixed on the water jacket member 125 can be narrowed by the downward movement of the transmission unit 112. In this embodiment, the larger the wind power 9 is, the narrower the spacing between the electric conductive member 124 and the permanent magnets 122 can be, and thus the more thermal energy can be generated. While the spacing H is narrowing, the elastic element 141 comes in to reject a possible direct contact between the electric conductive member 124 and the permanent magnets 122. As soon as the wind power 9 is stop, the elastic energy stored in the elastic element 141 would be release to bounce the transmission unit 112 and the permanent magnets 122 back to corresponding original heights.

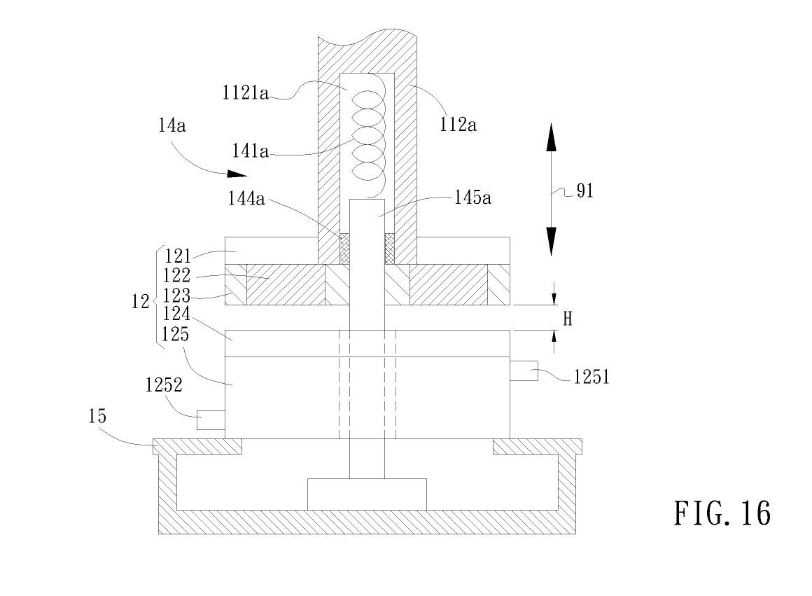

Referring now to FIG. 16, a second embodiment of the position adjusting mechanism for the water heating system in accordance with the present invention is schematically shown. In this embodiment, the electric conductive member 124 and the water jacket member 125 of the heat generating module 12 are stationary mounted on the chassis 15. The position adjusting mechanism 14a is formed as the end of the transmission unit 112a having a hollow slot 1121a. an elastic element 141a is nested inside the hollow slot 1121a. A shaft collar or a bearing 144a is installed interiorly to the hollow slot 1121a of the transmission unit 112a so as to sleeve one end of a rod 145a, while another end of the rod 145a is fixed to the chassis 15. In this embodiment, the rod 145a is a fixed structure, and does not move or rotate with the transmission unit 112a. While the power receiving module 11 is driven by the wind power 9, a downward forcing 91 will be generated to shift down the flywheel 121 and the permanent magnets 122 synchronically moved with the power receiving module 11 so as to narrow the spacing H between the permanent magnets 122 and the electric conductive member 124. Thereby, a larger thermal energy can be obtained.

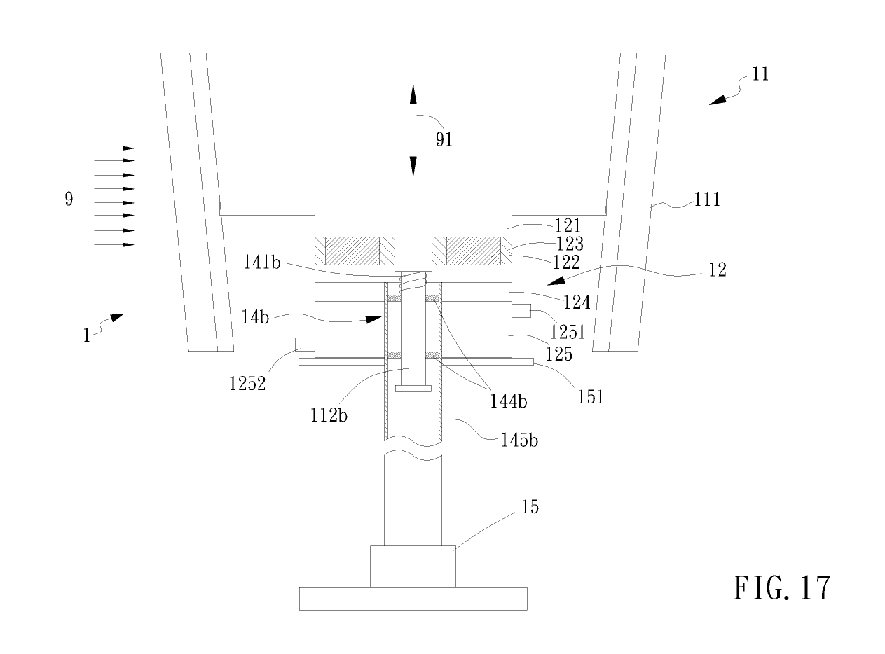

Referring now to FIG. 17, a third embodiment of the position adjusting mechanism for the water heating system in accordance with the present invention is schematically shown. In this embodiment, the flywheel 121 of the heat generating module 12 is directly locked to a center portion of the fan unit 111, and so is the magnet frame 123 as well as the permanent magnets 122 mounted thereon. The electric conductive member 124 and the water jacket member 125 are fixed to a stationary platform 151 on the chassis 15. The position adjusting mechanism 14b includes a pillar end of the transmission unit 112b sleeved by an elastic element 141b and a pillar pipe 145b to telescope at one end thereof the pillar end of the transmission unit 112b. A shaft collar or a bearing 144b located inside the pillar pipe 145b to hold slippery the pillar end of the transmission unit 112b. Another end of the pillar pipe 145b is fixed to the chassis 15. While the power receiving module 11 is driven by the wind power 9, a downward forcing 91 will be generated to shift down the flywheel 121 and the permanent magnets 122 synchronically moved with the transmission unit 112b of the power receiving module 11 so as to narrow the spacing H between the permanent magnets 122 and the electric conductive member 124. Thereby, a larger thermal energy can be obtained.

In the foregoing description related to FIGS. 15-17, three embodiments 14, 14a and 14b of the position adjusting mechanism are detailed. By applying any of the three embodiments 14, 14a and 14b, the spacing H between the permanent magnets 122 and the electric conductive member 124 can be adjusted automatically upon changes of the wind power 9. In particular, a rapid heating performance of the electric conductive member 124 can be obtained while in meeting a larger wind power 9. Also, in the case that a weak wind power 9 is met, the spacing H between the permanent magnets 122 and the electric conductive member 124 would become larger, and the induced eddy current would become smaller; such that even a tiny wind power can activate the power receiving module 11 to function. On the other hand, in the case that a strong wind power 9 is met, the spacing H between the permanent magnets 122 and the electric conductive member 124 would become smaller without possible direct contact, and more eddy currents can be induced in correspondence to high-speed operation of the power receiving module 11. Namely, upon such a situation, the temperature of the electric conductive member 124 would quickly increased, and thereby the heat conduction medium inside the water jacket member 125 can be rapidly heated up.

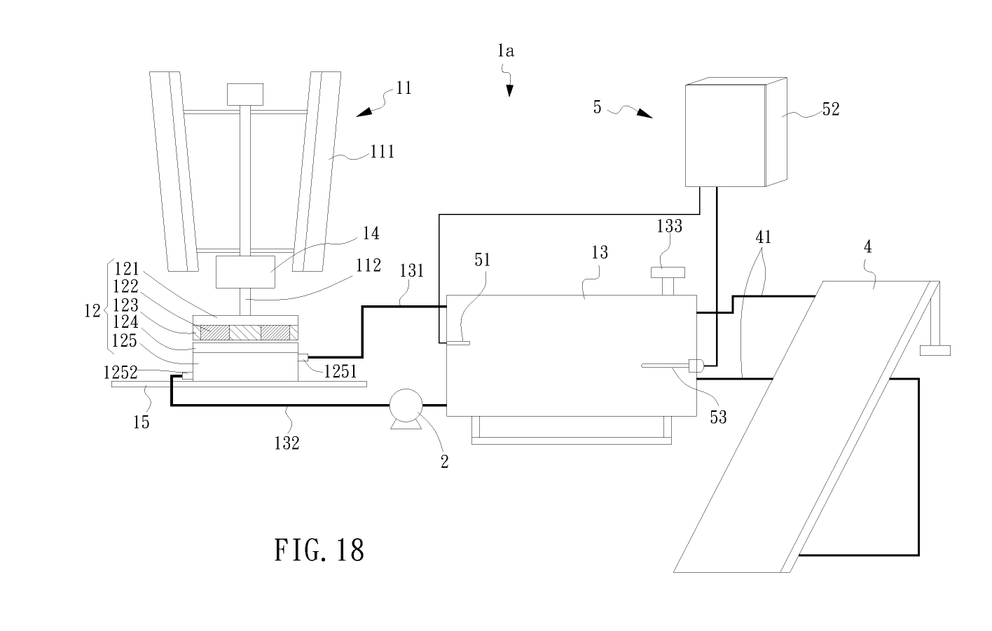

Referring now to FIG. 18, a schematic view of a second embodiment of the water heating system in accordance with the present invention is shown. The major difference between the second embodiment of FIG. 18 and the first embodiment of FIG. 1 is that the second embodiment of the water heating system la further includes a solar water heater 4 and an auxiliary heating device 5. The solar water heater 4 is connected by forming a close loop therewith to the heat storing module 13 to communicate the heat conduction medium via a piping 41. By providing the solar energy to be transformed into the thermal energy in the solar water heater 4, the high-temperature heat conduction medium inside the solar water heater 5 can be circulated by convection flow to the heat storing module via the piping 41.

The auxiliary heating device 5 further includes a temperature detector 51, a controller 52 and a heater 53. Both the temperature detector 51 and the heater 53 are mounted on the heat storing module 13 and are electrically coupled with the controller 52. The temperature detector 51 is to detect if the temperature inside the heat storing module 13 is low enough to activate the controller 52 to process a heating procedure of the heater 53 upon the heat storing module 13.

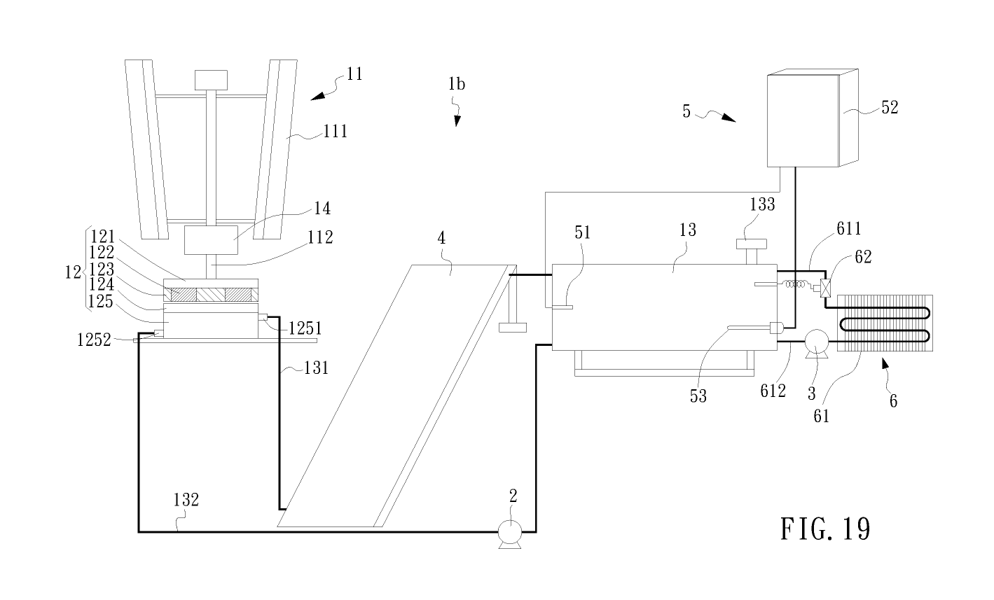

Referring now to FIG. 19, a schematic view of a third embodiment of the water heating system in accordance with the present invention is shown. The major difference between the second embodiment of FIG. 18 and the third embodiment of FIG. 19 is that, in order to avoid the system to be overheated from a whole-day heating operation, the third embodiment of the water heating system further includes an auxiliary heat-dissipation device 6 and an auxiliary circulation device 3. The auxiliary heat-dissipation device 6 further includes a heat-dissipating member 61 and a temperature valve 62. The heat-dissipating member 61 is formed as a winding piping in a heat-dissipating set having a plurality of heat-dissipating fins. The piping has a water inlet 611 and a water outlet 612 to connect with the heat storing module 13 so as to form a close loop of the heat conduction medium between the heat-dissipating member 61 and the heat storing module 13. The temperature valve 62 is installed at a predetermined location at the water inlet 611. Through the temperature valve 62 to detect if the temperature inside the heat storing module 13 is too high, a heat-dissipation process can be thus activated to flow out the heat conduction medium from the heat storing module 13 by a natural convection flow to the heat-dissipating member 61 for the required heat dissipation.

In the present invention, the auxiliary circulation device 3 for promoting the circulation of the heat conduction medium between the heat-dissipating member 61 and the heat storing module 13 can be a wind pump located at a predetermined position at the water outlet 612 of the heat-dissipating member 61. In addition, the solar water heater 4 can be either located directly at the intake pipe 131 of the heat storing module 13, or connected by opposing ends of the piping 41 to be located between the water jacket member 125 and the heat storing module 13 as shown in FIG. 19 and so as to keep temperature or heat up the heat conduction medium flowing from the water jacket member 125 to the heat storing module 13.

As described above, the water heating system 1 of the present invention includes a power receiving module 11 and a heat generating module 12. The power receiving module 11 further includes a fan unit 111 and a transmission unit 112. The heat generating module 12 connected with the transmission unit 112 further includes at least a flywheel 121, a plurality of permanent magnets 122, at least an electric conductive member 124 and at least a water jacket member 125. Upon the wind power 9 to rotate the fan unit 111 so as to further rotate the permanent magnets 122 on the flywheel 121 via the transmission unit 112, changes in magnetic field would occur at the predetermined spacing between the permanent magnets 122 and the electric conductive members 124 fixed to the water jacket member 125. While the electric conductive members 124 meet the changes in the magnetic field, eddy currents 7 would be induced to further generate heat on the electric conductive members 124. The heat is then conducted into the water jacket member 125 so as to heat up the heat conduction medium thereinside and to be further conserved in the heat storing module 13 by flowing the heat conduction medium from the water jacket member 125 to the heat storing module 13.

In the present invention, installations of the power receiving module 11 and the heat generating module 12 for the water heating system can be preferably carried out by, but not limited to, a vertical power shaft. Of course, other types of installations (a horizontal shafting installation for example) can be also relevant to the present invention, as long as such an installation can facilitate the connection with the heat generating system as well as the heat-generation operations. Importantly, a major concern of the installation of the power receiving unit is if such an installation can contribute a larger power capacity and a higher operation speed.

In the present invention, the heat generation mechanism for the heat generating module 12 is to utilize the permanent magnets 122 and the electric conductive member 124 to perform an electro-thermal transformation. The structuring for achieving the heat-generation and heat-reservation in accordance with the present invention is less complicated, inexpensive and endurable. Further, for the present invention needs no additional electricity, risk in electric hazards can be thus avoided. Moreover, for the present invention does not include a generator, complicate circuiting and coiling for the establishing the generator can be waived, and therefore any electric overloading that leads to a possible fire can thereby be eliminated.

By providing the water heating system of the present invention, while in the windy autumn and winter, more wind power can be available 24 hours a day for producing thermal energy. Therefore, convenient thermal energy as well as the hot water can be available the whole day as long as there is a wind. According to the present invention, various auxiliary devices can be accompanied so as to meet different needs in home, agricultural, commercial, or industrial usages.

While the present invention has been particularly shown and described with reference to a preferred embodiment, it will be understood by those skilled in the art that various changes in form and detail may be without departing from the spirit and scope of the present invention.

What is claimed is:

1. A water heating system, comprising:
a power receiving module, further including a fan unit and a transmission unit, the fan unit being driven by a natural flow to rotate the transmission unit; and
a heat generating module, connected with the transmission unit, further including at least a flywheel engaged with the transmission unit, a plurality of permanent magnets fixed at the at least a flywheel, at least an electric conductive member located respectively to the plurality of permanent magnets, and at least a water jacket member engaged fixedly with the at least an electric conductive member;
wherein, as the fan unit rotates the transmission unit so as to rotate synchronically the permanent magnets on the flywheel with respect to the stationary electric conductive member, a thermal energy is induced at the electric conductive member, and the thermal energy is then conducted to the water jacket member so as to heat up a heat conduction medium thereinside.

2. The water heating system according to claim 1, further including a heat storing module, the heat storing module and said water jacket member being formed as a close fluid loop of said heat conduction medium by having an intake pipe and an outgo pipe of the heat storing module to connect respectively with a water outlet and a water inlet of said water jacket member.

3. The water heating system according to claim 1, further including at least a magnet frame fixed to said flywheel to mount said permanent magnets; said permanent magnets being shaped to be one of round, trapezoidal, triangular, polygonal and irregular-cross sectional cylindrical; two said neighboring permanent magnets having different polarities.

4. The water heating system according to claim 1, further including a position adjusting mechanism located between said power receiving module and said heat generating module for adjusting a spacing between said permanent magnets and said electric conductive member.

5. The water heating system according to claim 1, wherein said water jacket member is formed as one of a round water jacket member having an interior spiral structure and a square water jacket member having an interior winding structure.

6. The water heating system according to claim 2, further including include an auxiliary circulation module formed as a wind pump located at a predetermined position of said outgo pipe of said heat storing module to help circulation of said heat conduction medium inside said heat storing module and said water jacket member.

7. The water heating system according to claim 1, wherein said permanent magnets are trapezoidal and arranged circularly around said flywheel which is cylindrically formed, said water jacket member being formed as a hollow cylindrical structure, said electric conductive member being formed as an inner shell fixed to the hollow cylindrical structure in a manner of outer to said permanent magnets by a predetermined annular spacing.

8. The water heating system according to claim 2, further including:
a solar water heater, connected by forming a close loop therewith to said heat storing module so as to communicate said heat conduction medium via a piping, further the solar water heater able to be located between said water jacket member and said heat storing module by applying two opposing ends of the piping to connect with said water jacket member and said heat storing module, respectively; and
an auxiliary heating device, further including a temperature detector, a controller and a heater, the temperature detector and the heater being mounted on said heat storing module and electrically coupled with the controller, the temperature detector detecting if a temperature inside said heat storing module is low enough to activate the controller to process a heating procedure of the heater upon said heat storing module.

9. The water heating system according to claim 8, further including:
an auxiliary heat-dissipation device, further including a heat-dissipating member and a temperature valve, the heat-dissipating member being formed as a winding piping in a heat-dissipating set having a plurality of heat-dissipating fins, the winding piping having a water inlet and a water outlet to connect with said heat storing module so as to form a close loop of said heat conduction medium between the heat-dissipating member and said heat storing module, the temperature valve being installed at a predetermined location at the water inlet, through the temperature valve to detect if a temperature inside said heat storing module is high enough to activate a heat-dissipation process to flow out said heat conduction medium from said heat storing module to the heat-dissipating member for required heat dissipation; and
an auxiliary circulation device for promoting circulation of said heat conduction medium between the heat-dissipating member and said heat storing module, formed as a wind pump located at a predetermined position at the water outlet of the heat-dissipating member.

10. The water heating system according to claim 4, wherein said position adjusting mechanism includes a central hollow slot built inside said transmission unit, an elastic element nested inside the central hollow slot, and a spline shaft having one end protruding upward to depress upon the elastic element inside the hollow slot, another end of the spline shaft being hold by a bearing located at a chassis; as said transmission unit being rotated by a wind power, a downward forcing upon said transmission unit being contributed to narrow said spacing between said permanent magnets synchronically moved with said transmission unit and said electric conductive member fixed to the spline shaft.

11. The water heating system according to claim 4, wherein said position adjusting mechanism includes a central hollow slot built inside said transmission unit, an elastic element nested inside the central hollow slot, a shaft collar installed interiorly to the hollow slot, and a rod having one end to be sleeved by the shaft collar and to protrude upward to depress upon the elastic element inside the hollow slot, another end of the rod being fixed to a chassis; as said transmission unit being rotated by a wind power, a downward forcing upon said transmission unit being contributed to narrow said spacing between said permanent magnets synchronically moved with said transmission unit and said electric conductive member fixed to the rod.

12. The water heating system according to claim 4, wherein said flywheel of said heat generating module is directly locked to a center portion of the fan unit, said electric conductive member and said water jacket member are fixed to a stationary platform on a chassis, and said position adjusting mechanism includes a pillar end of said transmission unit sleeved by an elastic element, a pillar pipe which telescopes the pillar end at one end thereof, and a shaft collar located inside the pillar pipe to hold slippery the pillar end, another end of the pillar pipe being fixed to a chassis; as said transmission unit being rotated by a wind power, a downward forcing upon said transmission unit being contributed to narrow said spacing between said permanent magnets synchronically moved with said transmission unit and said electric conductive member fixed to the pillar pipe.
